(19) United States
(12) Patent Application Publication
(10) Pub. No.: US 2024/0403103 A1
(43) Pub. Date: Dec. 5, 2024

(54) FRAMEWORK FOR INTEGRATION AND MANAGEMENT OF COMPUTER-BASED MODELS

(71) Applicant: Palantir Technologies Inc., Denver, CO (US)

(72) Inventors: Jakob Frick, London (GB); Sriram Krishnan, Jersey City, NJ (US); Thomas Powell, London (GB); David Lisuk, Brooklyn, NY (US); Mayada Gonimah, New York, NY (US)

(21) Appl. No.: 18/674,650

(22) Filed: May 24, 2024

Related U.S. Application Data
(60) Provisional application No. 63/505,681, filed on Jun. 1, 2023.

(51) Int. Cl. G06F 9/455; G06F 3/0484

(52) U.S. Cl. CPC G06F 9/45558; G06F 3/0484; G06F 2009/45562

(57) ABSTRACT

Computer-implemented systems and methods are disclosed, including for integration and management of computer-based models in a model management. A computer-implemented method may include, for example, receiving one or more inputs including requesting to add a first model to a defined modeling objective, specifying a first model location, and/or providing a first model adapter configuration. In response to the one or more user inputs, the method may further include storing or providing access to information associated with the first model, associating the first model with a defined modeling objective, and/or implementing the first model adapter configuration to provide communication with the first model.

### CROSS-REFERENCE TO RELATED APPLICATIONS

This application claims the benefit of U.S. Provisional Application No. 63/505,681, filed Jun. 1, 2023, titled “FRAMEWORK FOR INTEGRATION AND MANAGEMENT OF COMPUTER-BASED MODELS.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for data integration, analysis, and visualization. More specifically, the present disclosure relates to systems and a framework for integration and management of computer-based models in a model management system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computers can be programmed to perform calculations and operations utilizing one or more computer-based models. Various techniques have been developed to minimize the effort required by a human user in adapting and reprogramming the computer for utilizing such computer-based models.

### SUMMARY

The systems, methods, and devices described herein each have several aspects, no single one of which is solely responsible for its desirable attributes. Without limiting the scope of this disclosure, several non-limiting features will now be described briefly.

Computer-based models (generally referred to herein as “models”) have become important tools in managing the complexities of modern enterprises. Various systems can manage and deploy these models. For example, these systems can be used both in an interactive (live) mode where models are continuously applied to input data within a data pipeline, or a batch mode where the models are applied to a set of input data on a specific frequency. The features and capabilities of systems built to manage and deploy these models can range from platform to platform. For example, cloud hosting services may offer generic model management solutions while an individual business might invest in building a bespoke model management system. Over time, multiple models and model management systems may be employed, inevitably resulting in incompatibilities across multiple models and modeling systems. For example, users may be required to recreate models for each modeling system. Furthermore, it can be difficult to manage the flow of data and the state of the models when transitioning between different model management systems, especially as some systems do not provide basic versioning or the ability to manage inputs and outputs of multiple models. As modeling needs evolve, model and modeling management system incompatibilities may inhibit a transition from an obsolete model to a more effective model as addressing incompatibilities may be non-trivial.

The present disclosure includes a system and/or framework for centralized model integration and management (generally referred to herein as “the model management system” or “the system”). The present disclosure further includes various processes, functionality, and interactive graphical user interfaces related to the system. According to various implementations, the system (and related processes, functionality, and interactive graphical user interfaces), can advantageously provide for integration and management of multiple (including large numbers of) models in a consistent and centralized way which does not necessarily require model(s) to be moved from their current location or changed given that other configuration information, such as adaptor model configuration data, can determine how data is to be input and output, in which format(s) and may specify other criteria including access control or permissions criteria that limits which information the model can access in performance of its objective(s). The system may operate to manage models directly on centralized data pipelines for one or more defined modeling objectives without having to move data between bespoke modeling systems manually. This is possible because the system of the present disclosure can interoperate with a plurality of internal and external models for a defined modeling objective. As well as keeping all relevant information in one location, this further facilitates updates and modifications to be performed centrally. Where external models are utilized which may run on external processing systems or platforms, the potentially greater processing capabilities of those processing systems or platforms can be utilized notwithstanding that the integration and management side is handled centrally on a system or platform with less processing capabilities.

The system may be flexible enough to allow for several modeling integrations based on a defined modeling objective. For example, the system can configure a new model for a defined modeling objective hosted on the current system, generate a new model within the host system that maintains parity with a model hosted on another platform, or incorporate a third-party model hosted on a third-party platform, where the third-party model interacts with, but does not run on the host system (referred to as a “container route”). When integrating a third-party model via the container route, the system may be able to generate a container by packaging the third-party model as a binary asset and by moving the container onto the host system where the model can be consumed with other models. Advantageously, the system can integrate several opensource models into a single host system via the container route.

The system can receive one or more inputs from an interactive user interface and determine a modeling objective, select and add one or more models to the dependencies objective, provide access to the models via the modeling location information, configure the models via model-specific model adapter configurations, simulate the models in modeling environments, and manage prioritization of the models. The system can further, for each given defined modeling objective, execute a respective designated “production” model of the modeling objective when requests are received by the modeling objective. For example, a request to execute the modeling objective on particular data inputs may be received from a requestor, such as a user, another system, and/or various services. In response, the modeling objective may cause the data inputs to be provided to a model (e.g., a production model) of the modeling objective, and the model may be executed on the data inputs (e.g., in accordance with the model adapter configuration and/or other configurations associated with the model). Then, the output of the model can be provided back to the requestor via the defined modeling objective, as further described herein.

The system can request that a user define, and/or can receive from a user and/or other system, a modeling objective (also referred to herein as a “defined modeling objective”). A defined modeling objective can be representative of any task or objective, such as a processing, prediction, estimation, and/or analysis task (and/or the like). A modeling objective can be associated with one or more models configured to execute a portion of, or the entire task or objective associated with the modeling objective. The defined modeling objective can include specifications regarding how input data from users, applications, or systems should be provided to the modeling objective (and/or consumed by one or more models associated with the modeling objective), and how output data to users, applications, or systems should be provided by the modeling objective. Such input and output specifications can include, for example, data formats, data schemas, data types, and/or the like. Such input and output specification of a defined modeling objective may be referred to as an objective API (“application programming interface”). Further, configuration of an objective API can define how inputs and outputs to the model should be mapped to an ontology of the system when invoked interactively. For example, a modeling objective can be used to determine software vulnerabilities in a computer network. Inputs to such a modeling objective, as defined by the modeling objective data can include real world properties such as name and/or type of computer or application, number of computers or applications in the computer network, and known or recent detected malware or virus attacks on same or similar computers or applications, while the modeling objective output as defined by the modeling objective data can include an estimated vulnerability score for the computer network or parts thereof. As another example, a modeling objective can be used to determine housing prices in the United States. Inputs to such a modeling objective can include real world properties such as house location, number of rooms, square footage, and recently sold home prices, while the modeling objective output can include an estimated house price.

The system can further request that a user select a model to be configured. The system may provide the user with one or more models for selection based on the defined modeling objective. The system can request that a user select an internal model located within the host system, or request selection or specification of an object representing a model hosted by a third-party platform. Specifying such an object can include providing details necessary for communicating and/or interacting with the model hosted by the third-party platform (e.g., via one or more APIs). Models located within the system can include both code representing the actual modeling data as well as object data representing characteristics of the model, while models hosted on third-party platforms may be represented by object data within the system. Object data representing characteristics defining parameters, interactions, and execution of either an internal model or a third-party model can include, for example, data sources, instructions, permissions, lineage, governance, auditability, and an allocation of resources.

Further the system may request that the user select a model location for the selected model. A model location can be, for example, a location within the system. The modeling location can store model data as well as object data defined for each model. Advantageously, model location selection is agnostic with models internal to the system as well as models externally hosted by a third-party platform because the system treats object data defined for internal and external models as similar assets. Also, the models may not changed or moved from their current location or platform, in some implementations. For example, substantiation and configuration of internal and external models, as well as user permissions may be included as part of an internal and external model's object data.

The system can generate and/or the user can specify model adapter configurations based on user inputs. A model adapter configuration can include specific instructions defining implementation criteria of a selected internal or external model for a defined modeling objective. Instructions can range in scope and quantity based on the selected model or models implemented in the defined modeling objective. For example, instructions within a model adapter can include loading, saving, or execution instructions. Instructions may optionally include permissioning criteria, limiting access to select users for the selected model. The model adapter configuration may include additional instructions for configuring the functionality and communication between a model and a defined modeling objective. The model adapter configuration can further include definitions and/or formats for expected data input and output types of the model, specifications for parameters or properties of the model, and/or the like. For example, data input and output types can include a string, text, binary, floating point, character, Boolean, timestamp, and/or date. Additionally, definitions and/or formats for expected data input and data output types can include, for example, the number of columns for input or output data, column header information, whether the input or output data is in tabular form or from a filesystem (and/or in another data format), and how the selected model should receive and process new input data (such as for example, via a batch or live operation). The model adapter configuration can further include scheduling instructions for dependencies, such as a list of necessary data to be accessed and consumed by the selected model, or specific rules based on the operating platform of the model (e.g., python) without requiring that the model operate in the specific operating platform environment.

Additionally, the model adapter configuration can include instructions governing specific criteria for input and output data of a selected model within the defined modeling objective, called “fine-tuned” data. Examples of fine-tuned data can include domain specific language tailored to the selected model or training data that can manually adjust one or more characteristics or functions of a selected model to better incorporate the selected model into a specific modeling objective.

The model adapter configuration instructions can be represented by, for example, a set of binary files or generic files determining the interaction between the system and the selected model for a defined modeling objective. Additionally, the user may be able to generate more than one model adapter configuration for a selected model, thereby providing the user with the flexibility to define a plurality of distinct instructions for incorporating a model into a defined modeling objective. Advantageously, the system's ability to generate model adapter configurations can provide a user with the means necessary to quickly generate complex binary files or generic files that are required to incorporate internal or external models into a system for a defined modeling objective.

The system can simulate one or more internal or external models through a “sandbox” simulation. The sandbox simulation can provide a simulated modeling environment for a defined modeling objective, allowing a user to test one or more configured models within a defined modeling objective prior to production releasing the models. Advantageously, a sandbox simulation may establish a simulated environment for an internal model hosted on the system or for an external model hosted by a third-party platform. When an external model hosted by a third-party is implemented as part of the sandbox simulation, a URL is generated by the sandbox simulation allowing the external model to easily access the sandbox simulation modeling environment. The modeling environment implemented within the sandbox simulation can be the same as, or of a similar type as the defined modeling objective. For example, the sandbox simulation environment can simulate an entire modeling objective or any portion of the defined modeling objective implementing the selected model or models. In a further example, the sandbox simulation can simulate an objective API environment, or one or more models that sources files and simulates an operational or computing environment within the system.

Advantageously, the generated sandbox simulation of the system provides a means for resolving integration issues for one or more selected models without requiring the overhead of production releasing a model. For example, when a user requests a sandbox simulation for a selected model, the system can provide the user with access to troubleshooting and/or testing data (such as, e.g., testing points, performance data, telemetry data, asset utilization data, and/or the like), as well as access to input and output data of the selected model without affecting the defined modeling objective or other modeling objectives that may apply the selected model in production environments. As part of the sandbox simulation, a user may further configure characteristics of the simulation environment by setting maximum resource levels allocated to the selected model, or by setting permissions restricting access to the sandbox simulation. Advantageously, the system can provide an expiration time for the sandbox simulation. An expiration time can be determined based on a user input represented by, for example; a date, a time, or a duration. Once the expiration time passes, the system can automatically delete the sandbox simulation, which in turn deletes the simulated modeling environment for the selected model. Advantageously, deleting the simulated modeling environment can prevent waste and conserve energy and resources within the system as unused simulation environments may still consume energy and resources from the system even when not in use.

A system can display a list of models for a defined modeling objective and provide for selection of one or more models for deployment (and/or, for example, prioritizing). The system can provide the user with an organized representation and interaction with a listing of models and the different contexts where each model is used within the system. Advantageously, a display of models and the different context where the models are implemented can be leveraged by a user to quickly conduct an impact analysis and determine the scope of possible changes when considering whether to promote a selected model from, for example, a staged released (e.g., pre-production release) version to a production released version.

For example, after sandbox simulation testing of a selected model, the system can promote the selected model to a staged release (e.g., pre-production). The system designated staged released version of a model can represent a version-controlled model for use in a testing environment, providing access for the user or a third-party user to interact with the promoted model without affecting production releases of the model. Further, the system may promote the selected model to a production released version. When the system designates the selected model as a production released version, the system may automatically deploy the newly promoted model within each modeling objective where the selected model is labeled for production use.

According to various implementations, the system can incorporate and/or communicate with one or more LLMs to perform various functions. Such communications may include, for example, a context associated with an aspect or analysis being performed by the system, a user-generated prompt, an engineered prompt, prompt and response examples, example or actual data, and/or the like. For example, the system may employ an LLM, via providing an input to, and receiving an output from, the LLM. The output from the LLM may be parsed and/or a format of the output may be updated to be usable for various aspects of the system.

The system may employ an LLM to, for example, determine a modeling objective (e.g., based on one or more models and/or other information), identify additional models that may be related to the modeling objective, determine or generate a model location, determine or generate a model adapter configuration, determine or generate a sandbox or container implementation, and/or the like.

According to various implementations, large amounts of data are automatically and dynamically calculated interactively in response to user inputs, and the calculated data is efficiently and compactly presented to a user by the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, models and model-related data, and may enable a user to more quickly and accurately access, navigate, assess, and digest the model-related data than previous systems.

Further, the interactive and dynamic user interfaces described herein are enabled by innovations in efficient interactions between the user interfaces and underlying systems and components. For example, disclosed herein are improved methods of receiving user inputs (including methods of interacting with, managing, and integrating models), translation and delivery of those inputs to various system components, automatic and dynamic execution of complex processes in response to the input delivery, automatic interaction among various components and processes of the system, and automatic and dynamic updating of the user interfaces (to, for example, display the model-related data). The interactions and presentation of data via the interactive user interfaces described herein may accordingly provide cognitive and ergonomic efficiencies, among various additional technical advantages over previous systems.

Thus, various implementations of the present disclosure can provide improvements to various technologies and technological fields, and practical applications of various technological features and advancements. For example, as described above, existing computer-based model management and integration technology is limited in various ways, and various implementations of the disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., processing and analysis of large amounts of electronic data, management of data migrations and integrations, and/or the like) are intimately tied to, and enabled by, computer technology, and would not exist except for computer technology. For example, the interactions with, and management of, computer-based models described below in reference to various implementations cannot reasonably be performed by humans alone, without the computer technology upon which they are implemented. Further, the implementation of the various implementations of the present disclosure via computer technology enables many of the advantages described herein, including more efficient management of various types of electronic data (including computer-based models).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise a computer-readable storage medium having program instructions embodied therewith, and one or more processors configured to execute the program instructions to cause the systems and/or computer systems to perform operations comprising one or more aspects of the above-and/or below-described implementations (including one or more aspects of the appended claims).

In various implementations, computer-implemented methods are disclosed in which, by one or more processors executing program instructions, one or more aspects of the above-and/or below-described implementations (including one or more aspects of the appended claims) are implemented and/or performed.

In various implementations, computer program products comprising a computer-readable storage medium are disclosed, wherein the computer-readable storage medium has program instructions embodied therewith, the program instructions executable by one or more processors to cause the one or more processors to perform operations comprising one or more aspects of the above-and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a schematic block diagram of an example model management system in an example computing environment;

FIG. 2 is a flow chart depicting an example routine for selecting and configuring a model as part of a model management system;

FIG. 3 is a flow chart depicting an example routine for generating a simulation environment as part of a model management system;

FIG. 4 is a flow chart depicting an example routine for organizing one or more models as part of a model management system;

FIG. 5 is a flow chart depicting an example routine for using a large language model as part of a model management system;

FIGS. 6A-6B, 7A-7B, 8, and 9 are illustrations of example user interfaces of a model management system; and

FIG. 10 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### 1. Overview

As noted above, computer-based models (generally referred to herein as “models”) have become important tools in managing the complexities of modern enterprises. Various systems can manage and deploy these models. For example, these systems can be used both in an interactive (live) mode where models are continuously applied to input data within a data pipeline, or a batch mode where the models are applied to a set of input data on a specific frequency. The features and capabilities of systems built to manage and deploy these models can range from platform to platform. For example, cloud hosting services may offer generic model management solutions while an individual business might invest in building a bespoke model management system. Over time, multiple models and model management systems may be employed, inevitably resulting in incompatibilities across multiple models and modeling systems. For example, users may be required to recreate models for each modeling system. Furthermore, it can be difficult to manage the flow of data and the state of the models when transitioning between different model management systems, especially as some systems do not provide basic versioning or the ability to manage inputs and outputs of multiple models. As modeling needs evolve, model and modeling management system incompatibilities may inhibit a transition from an obsolete model to a more effective model as addressing incompatibilities may be non-trivial.

As also noted above, the present disclosure includes a system and/or framework for centralized model integration and management (generally referred to herein as “the model management system” or “the system”). The present disclosure further includes various processes, functionality, and interactive graphical user interfaces related to the system. According to various implementations, the system (and related processes, functionality, and interactive graphical user interfaces), can advantageously provide for management of multiple (including large numbers of) models in a consistent and centralized way. The system may operate to manage models directly on centralized data pipelines for one or more defined modeling objectives without having to move data between bespoke modeling systems manually. This is possible because the system of the present disclosure can interoperate with a plurality of internal and external models for a defined modeling objective.

The system may be flexible enough to allow for several modeling integrations based on a defined modeling objective. For example, the system can configure a new model for a defined modeling objective hosted on the current system, generate a new model within the host system that maintains parity with a model hosted on another platform, or incorporate a third-party model hosted on a third-party platform, where the third-party model interacts with, but does not run on the host system (referred to as a “container route”). When integrating a third-party model via the container route, the system may be able to generate a container by packaging the third-party model as a binary asset and by moving the container onto the host system where the model can be consumed with other models. Advantageously, the system can integrate several opensource models into a single host system via the container route.

The system can receive one or more inputs from an interactive user interface and determine a modeling objective, select and add one or more models to the dependencies objective, provide access to the models via the modeling location information, configure the models via model-specific model adapter configurations, simulate the models in modeling environments, and manage prioritization of the models. The system can further, for each given defined modeling objective, execute a respective designated “production” model of the modeling objective when requests are received by the modeling objective. For example, a request to execute the modeling objective on particular data inputs may be received from a requestor, such as a user, another system, and/or various services. In response, the modeling objective may cause the data inputs to be provided to a model (e.g., a production model) of the modeling objective, and the model may be executed on the data inputs (e.g., in accordance with the model adapter configuration and/or other configurations associated with the model). Then, the output of the model can be provided back to the requestor via the defined modeling objective, as further described herein.

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality, such as described in, for example: Ashish Vaswani, et al., “Attention is all you need,” Advances in Neural Information Processing Systems, pp. 5998-6008 (2017); and U.S. Pat. Nos. 10,452,978 and 11,556,786.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic processes. Similarly, while certain aspects and implementations are discussed herein with reference to use of a ML model, those aspects and implementations may be performed by any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

A data store can be any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage).

A database can be any data structure (and/or combinations of multiple data structures) for storing and/or organizing data, including, but not limited to, relational databases (e.g., Oracle databases, PostgreSQL databases, MySQL databases and the like), non-relational databases (e.g., NoSQL databases, and the like), in-memory databases, spreadsheets, as comma separated values (“CSV”) files, extensible markup language (“XML”) files, TEXT (“TXT”) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various embodiments such data may be combined and/or separated in any appropriate way into one or more databases, one or more tables of one or more databases, and/or the like.

A data item can be a data representation or container for information representing a specific thing in the world that have a number of definable properties. For example, a data item can represent an entity such as a physical object, a parcel of land or other real property, a market instrument, a policy or contract, or other noun. Each data item may be associated with a unique identifier that uniquely identifies the data item. The item's attributes (e.g. metadata about the object) may be represented in one or more properties. Attributes may include, for example, a geographic location associated with the item, a value associated with the item, a probability associated with the item, an event associated with the item, and so forth.

### Example Aspects Related to the Modeling Objective

The system can request that a user define, and/or can receive from a user and/or other system, a modeling objective (also referred to herein as a “defined modeling objective”). A defined modeling objective can be representative of any task or objective, such as a processing, prediction, estimation, and/or analysis task (and/or the like). A modeling objective can be associated with one or more models configured to execute a portion of, or the entire task or objective associated with the modeling objective. The defined modeling objective can include specifications regarding how input data from users, applications, or systems should be provided to the modeling objective (and/or consumed by one or more models associated with the modeling objective), and how output data to users, applications, or systems should be provided by the modeling objective. Such input and output specifications can include, for example, data formats, data schemas, data types, and/or the like. Such input and output specification of a defined modeling objective may be referred to as an objective API (“application programming interface”). Further, configuration of an objective API can define how inputs and outputs to the model should be mapped to an ontology of the system when invoked interactively. For example, a modeling objective can be used to determine software vulnerabilities in a computer network. Inputs to such a modeling objective, as defined by the modeling objective data 121 can include real world properties such as name and/or type of computer or application, number of computers or applications in the computer network, and known or recent detected malware or virus attacks on same or similar computers or applications, while the modeling objective output as defined by the modeling objective data 121 can include an estimated vulnerability score for the computer network or parts thereof. As another example, a modeling objective can be used to determine housing prices in the United States. Inputs to such a modeling objective can include real world properties such as house location, number of rooms, square footage, and recently sold home prices, while the modeling objective output can include an estimated house price.

### Example Aspects Related to Model Selection

The system can further request that a user select a model to be configured. The system may provide the user with one or more models for selection based on the defined modeling objective. The system can request that a user select an internal model located within the host system, or request selection or specification of an object representing a model hosted by a third-party platform. Specifying such an object can include providing details necessary for communicating and/or interacting with the model hosted by the third-party platform (e.g., via one or more APIs). Models located within the system can include both code representing the actual modeling data as well as object data representing characteristics of the model, while models hosted on third-party platforms may be represented by object data within the system. Object data representing characteristics defining parameters, interactions, and execution of either an internal model or a third-party model can include, for example, data sources, instructions, permissions, lineage, governance, auditability, and an allocation of resources.

Further the system may request that the user select a model location for the selected model. A model location can be, for example, a location within the system. The modeling location can store model data as well as object data defined for each model. Advantageously, model location selection is agnostic with models internal to the system as well as models externally hosted by a third-party platform because the system treats object data defined for internal and external models as similar assets. For example, substantiation and configuration of internal and external models, as well as user permissions may be included as part of an internal and external model's object data.

### Example Aspects Related to Model Adapter Configuration

The system can generate and/or the user can specify model adapter configurations based on user inputs. A model adapter configuration can include specific instructions defining implementation criteria of a selected internal or external model for a defined modeling objective. Instructions can range in scope and quantity based on the selected model or models implemented in the defined modeling objective. For example, instructions within a model adapter can include loading, saving, or execution instructions. Instructions may optionally include permissioning criteria, limiting access to select users for the selected model. The model adapter configuration may include additional instructions for configuring the functionality and communication between a model and a defined modeling objective. The model adapter configuration can further include definitions and/or formats for expected data input and data output types of the model, specifications for parameters or properties of the model, and/or the like. For example, data input and output types can include a string, text, binary, floating point, character, Boolean, timestamp, and/or date. Additionally, definitions and/or formats for expected data input and data output types can include, for example, the number of columns for input or output data, column header information, whether the input or output data is in tabular form or from a filesystem (and/or in another data format), and how the selected model should receive and process new input data (such as for example, via a batch or live operation). The model adapter configuration can further include scheduling instructions for dependencies, such as a list of necessary data to be accessed and consumed by the selected model, or specific rules based on the operating platform of the model (e.g., python) without requiring that the model operate in the specific operating platform environment.

Additionally, the model adapter configuration can include instructions governing specific criteria for input and output data of a selected model within the defined modeling objective, called “fine-tuned” data. Examples of fine-tuned data can include domain specific language tailored to the selected model or training data that can manually adjust one or more characteristics or functions of a selected model to better incorporate the selected model into a specific modeling objective.

The model adapter configuration instructions can be represented by, for example, a set of binary files or generic files determining the interaction between the system and the selected model for a defined modeling objective. Additionally, the user may be able to generate more than one model adapter configuration for a selected model, thereby providing the user with the flexibility to define a plurality of distinct instructions for incorporating a model into a defined modeling objective. Advantageously, the system's ability to generate model adapter configurations can provide a user with the means necessary to quickly generate complex binary files or generic files that are required to incorporate internal or external models into a system for a defined modeling objective.

### Example Aspects Related to Sandbox Simulation

The system can simulate one or more internal or external models through a “sandbox” simulation. The sandbox simulation can provide a simulated modeling environment for a defined modeling objective, allowing a user to test one or more configured models within a defined modeling objective prior to production releasing the models. Advantageously, a sandbox simulation may establish a simulated environment for an internal model hosted on the system or for an external model hosted by a third-party platform. When an external model hosted by a third-party is implemented as part of the sandbox simulation, a URL is generated by the sandbox simulation allowing the external model to easily access the sandbox simulation modeling environment. The modeling environment implemented within the sandbox simulation can be the same as, or of a similar type as the defined modeling objective. For example, the sandbox simulation environment can simulate an entire modeling objective or any portion of the defined modeling objective implementing the selected model or models. In a further example, the sandbox simulation can simulate an objective API environment, or one or more models that sources files and simulates an operational or computing environment within the system.

Advantageously, the generated sandbox simulation of the system provides a means for resolving integration issues for one or more selected models without requiring the overhead of production releasing a model. For example, when a user requests a sandbox simulation for a selected model, the system can provide the user with access to troubleshooting and/or testing data (such as, e.g., testing points, performance data, telemetry data, asset utilization data, and/or the like), as well as access to input and output data of the selected model without affecting the defined modeling objective or other modeling objectives that may apply the selected model in production environments. As part of the sandbox simulation, a user may further configure characteristics of the simulation environment by setting maximum resource levels allocated to the selected model, or by setting permissions restricting access to the sandbox simulation. Advantageously, the system can provide an expiration time for the sandbox simulation. An expiration time can be determined based on a user input represented by, for example; a date, a time, or a duration. Once the expiration time passes, the system can automatically delete the sandbox simulation, which in turn deletes the simulated modeling environment for the selected model. Advantageously, deleting the simulated modeling environment can prevent waste and conserve energy and resources within the system as unused simulation environments may still consume energy and resources from the system even when not in use.

### Example Aspects Related to Model Deployment

A system can display a list of models for a defined modeling objective and provide for selection of one or more models for deployment (and/or, for example, prioritizing). The system can provide the user with an organized representation and interaction with a listing of models and the different contexts where each model is used within the system. Advantageously, a display of models and the different context where the models are implemented can be leveraged by a user to quickly conduct an impact analysis and determine the scope of possible changes when considering whether to promote a selected model from, for example, a staged released (e.g., pre-production release) version to a production released version.

For example, after sandbox simulation testing of a selected model, the system can promote the selected model to a staged release (e.g., pre-production). The system designated staged released version of a model can represent a version-controlled model for use in a testing environment, providing access for the user or a third-party user to interact with the promoted model without affecting production releases of the model. Further, the system may promote the selected model to a production released version. When the system designates the selected model as a production released version, the system may automatically deploy the newly promoted model within each modeling objective where the selected model is labeled for production use.

### Example Aspects Related to LLM Functionality

According to various implementations, the system can incorporate and/or communicate with one or more LLMs to perform various functions. Such communications may include, for example, a context associated with an aspect or analysis being performed by the system, a user-generated prompt, an engineered prompt, prompt and response examples, example or actual data, and/or the like. For example, the system may employ an LLM, via providing an input to, and receiving an output from, the LLM. The output from the LLM may be parsed and/or a format of the output may be updated to be usable for various aspects of the system.

The system may employ an LLM to, for example, determine a modeling objective (e.g., based on one or more models and/or other information), identify additional models that may be related to the modeling objective, determine or generate a model location, determine or generate a model adapter configuration, determine or generate a sandbox or container implementation, and/or the like.

### II. Example Model Management System and Related Computing Environment

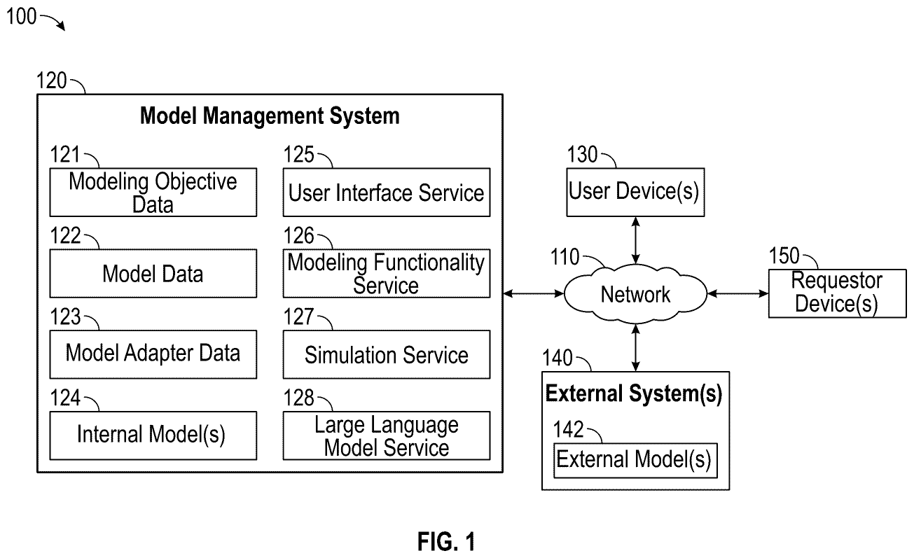

FIG. 1 illustrates an example computing environment 100 including a model management system 120 (referred to herein as “system 120”). The system 120 may include modeling objective data 121, model data 122, model adapter data 123, internal model(s) 124, a user interface service 125, a modeling functionality service 126, and a simulation service 127. The system 120 may be connected via network 110 to other computing devices, such as user device(s) 130, external system(s) 140, and requestor device(s) 150. External system(s) 140 may include external model(s) 142. For example, user device(s) 130 may transmit a request to the system 120, to execute one or more models located on external system(s) 140. The system 120 may receive the request from the user device(s) 130 and in response, transmit a request to the external system(s) 140 to execute one or more external model(s) 142. The external system(s) 140 may receive the request from the system 120 and in response, execute one or more external model(s) 142, and transmit to the user device(s) 130, requestor device(s) 150, and/or the system 120, information based on the results of the external model(s) 142.

Modeling objective data 121 can include data representing any task or objective, such as a processing, prediction, estimation, and/or an analysis task (and/or the like). Modeling objective data 121 can include instructions associated with one or more internal model(s) 124 and/or instructions associated with one or more external models, such as external model(s) 142 of external system(s) 140. The instructions can be configured to execute a portion of, or the entire task or objective associated with a defined modeling objective. The modeling objective data 121 can include, for example, specifications regarding how input data from user device(s) 130, requestor device(s) 150, and/or applications, should be provided to the system 120 (and/or consumed by one or more models associated with the system 120). Additionally and/or alternatively, modeling objective data 121 can include specifications regarding how output data to user device(s) 130, requestor device(s) 150, and/or applications should be provided for a defined modeling objective. Such input and output specifications included as part of modeling objective data 121 can include, for example, data formats, data schemas, data types, and/or the like.

Such input and output specifications of modeling objective data 121 may be referred to, in one implementation, as an objective API (“application programming interface”). Further, configuration of an objective API can, define how inputs and outputs to a model should be mapped to an ontology of the system 120 when invoked interactively. For example, a defined modeling objective may include instructions for determining software vulnerabilities in a computer network. Inputs to such a modeling objective, as defined by the modeling objective data 121 can include real world properties such as name and/or type of computer or application, number of computers or applications in the computer network, and known or recent detected malware or virus attacks on same or similar computers or applications, while the modeling objective output as defined by the modeling objective data 121 can include an estimated vulnerability score for the computer network or parts thereof. As another example, a defined modeling objective may include instructions for determining housing prices in the United States. Inputs to such a modeling objective, as defined by the modeling objective data 121 can include real world properties such as house location, number of rooms, square footage, and recently sold home prices, while the modeling objective output as defined by the modeling objective data 121 can include an estimated house price.

Model data 122 can include object data representing characteristics of one or more models within the system 120, such as internal model(s) 124. Additionally and/or alternatively, model data 122 can include object data representing characteristics of associated models hosted on third-party platforms, such as external model(s) 142. Object data can include, for example, data sources, instructions, permissions, lineage, governance, auditability, and an allocation of resources for a model. Advantageously, model data 122 is agnostic with models internal to the system 120 as well as models externally hosted by a third-party platform because the system 120 treats model data 122 defined for internal and external models as similar assets. For example, substantiation and configuration of internal and external models, as well as user permissions may be included as part of an internal and external model's model data 122.

The model adapter data 123 can include specific instructions defining implementation criteria of a selected internal or external model for a defined modeling objective. Instructions can range in scope and quantity based on the associated modeling objective data 121. For example, instructions within model adapter data 123 can include loading, saving, or execution instructions. Instructions may optionally include permissioning criteria, limiting access to select users for one or more internal model(s) 124 and/or external model(s) 142. The model adapter data 123 may include additional instructions for configuring the functionality and communication between an internal and/or external model and a defined modeling objective. The model adapter data 123 can further include definitions and/or formats for expected input data types and output data types of a model, specifications for parameters or properties of a model, and/or the like. For example, input data types and output data types can include a string, text, binary, floating point, character, Boolean, timestamp, and/or date. Additionally, definitions and/or formats for expected input data types and output data types can include, for example, the number of columns for input or output data, column header information, whether the input or output data is in tabular form or from a filesystem (and/or in another data format), and how the selected model should receive and process new input data (such as for example, via a batch or live operation). The model adapter data 123 can further include scheduling instructions for dependencies, such as a list of necessary data to be accessed and consumed by the selected model, or specific rules based on the operating platform of the model (e.g., python) without requiring that the model operate in the specific operating platform environment.

Additionally, the model adapter data 123 can include instructions governing specific criteria for input and output data of a selected model within the defined modeling objective, called “fine-tuned” data. Examples of fine-tuned data can include domain specific language tailored to the selected model or training data that can manually adjust one or more characteristics or functions of a selected model to better incorporate the selected model into a specific modeling objective.

The model adapter data 123 can be represented by, for example, a set of binary files or generic files determining the interaction between the system 120 and a selected model for a defined modeling objective. Additionally, model adapter data 123 can provide more than one model adapter configuration for a selected model, thereby providing the user with the flexibility to define a plurality of distinct instructions for incorporating a model into a defined modeling objective. Advantageously, the ability to configure model adapter data 123 can provide a user with the means necessary to quickly generate complex binary files or generic files that are required to incorporate internal or external models into a system 120 for a defined modeling objective.

Internal model(s) 124 can be a datastore and/or other data structure storing one or more models. For example, internal model(s) 124 can include data representing a real-world event, a system or sub-system, a behavior, and/or a natural phenomenon. When executed, internal model(s) 124 may receive input data and/or generate output data and based on a defined modeling objective. Internal model(s) 124 may receive input data from for example, a second internal model, user device(s) 130, requestor device(s) 150, external model(s) 142 and/or another system as defined by modeling objective data 121, based on a request to execute a defined modeling objective.

User interface service 125 may allow the system 120 to interact with the user. User interface service 125 may generate a graphical user interface (“GUI”) displayed on a client device, such as user device(s) 130. User interface service 125 may also receive data entered by a user into a client device, such as user device(s) 130, and may store and/or forward it to the other various components of the system 120.

The modeling functionality service 126 may send and receive data to/from user device(s) 130, external system(s) 140, and/or requestor device(s) 150. For example, modeling functionality service 126 may connect to external system(s) 140 through an application programming interface (“API”) and retrieve or submit data to/from a one or more external model(s) 142 maintained on external system(s) 140 through appropriate API calls. Similarly, modeling functionality service 126 may receive data from an API from requestor device(s) 150 through appropriate API calls. Additionally, modeling functionality service 126 can execute steps and/or functions associated with a modeling objective. For example, based on a request from requestor device(s) 150, modeling functionality service 126 may provide input data to one or more internal model(s) 124, and/or one or more external model(s) 142, and execute steps and/or functions according to modeling objective data 121 associated with the request.

Further, modeling functionality service 126 may promote one or more selected models to a staged release version and/or a production released version within the system 120. When the modeling functionality service 126 designates the selected model as a production released version, the system 120 may automatically deploy the newly promoted model within each modeling objective where the selected model is labeled for production use. For example, a user may interact with a GUI to promote one or more models to a staged release and/or a production released version. The modeling functionality service 126 may receive and execute the promotion request from user interface service 125. When the modeling functionality service 126 designates the selected model as a production released version, the modeling functionality service 126 may automatically deploy the newly promoted model within each modeling objective where the selected model is labeled for production use.

The simulation service 127 can provide a simulated modeling environment (also referred to herein as a “sandbox” simulation and/or environment, and/or the like) for a defined modeling objective. The simulation service 127 can allow a user to test one or more configured models within a defined modeling objective prior to production releasing the models. Advantageously, a simulation service 127 may establish a simulated environment for internal model(s) 124 and/or external model(s) 142. When external model(s) 142 are implemented as part of the simulation service 127, a URL may be generated by the simulation service 127, allowing the external model(s) 142 to easily access the simulation modeling environment. The modeling environment implemented within the simulation service 127 can be the same as, or of a similar type as the environment generated as part of a defined modeling objective. For example, the simulation environment can simulate an entire modeling objective or any portion of the defined modeling objective implementing selected model(s). In a further example, the simulation service 127 can simulate an objective API environment, or model(s) that source files and simulate an operational or computing environment within the system 120.

Advantageously, simulation service 127 provides users with a means for resolving integration issues for one or more selected models without requiring the overhead of production releasing a model. For example, when a user requests a simulation for a selected model, the simulation service 127 can provide the user with access to troubleshooting and/or testing data (such as, e.g., testing points, performance data, telemetry data, asset utilization data, and/or the like), as well as access to input and output data of the selected model without affecting the defined modeling objective or other modeling objectives that may apply the selected model in production environments. As part of the simulation service 127, a user may further configure characteristics of the simulation environment by setting maximum resource levels allocated to the selected model, or by setting permissions restricting access to the sandbox simulation. Advantageously, the simulation service 127 can provide a user input requesting an expiration time for the simulation modeling environment. An expiration time can be determined based on a user input represented by, for example, a date, a time, or a duration. Once the expiration time passes, the system 120 can automatically delete the simulated modeling environment for the selected model. Advantageously, deleting the simulated modeling environment can prevent waste and conserve energy and resources within the system 120 as unused simulation environments may still consume energy and resources from the system 120 even when not in use.

The large language model service 128 can provide various LLM-related functionality of the system 120. The large language model service 128 may, for example, receive inputs to, and provide outputs from, one or more internal or external LLMs for various LLM functionality of the system described herein. In various implementations, the large language model service 128, and/or one or more LLMs accessible via the large language model service 128, may be locally hosted, cloud managed, accessed via one or more APIs, and/or any combination of the foregoing and/or the like. For example, a user may interact with a GUI via user interface service 125, and request to query information associated with a defined modeling objective. The large language model service 128 may receive the query, and transmit results based on the query to the user interface service 125. The user interface service 125 may update one or more GUIs based on the results from the large language model service 128.

Users may use user device(s) 130 to view and/or interact with a GUI provided by the user interface service 125. For example, the user device(s) 130 can include a wide variety of computing devices, including personal computing devices, terminal computing devices, laptop computing devices, tablet computing devices, electronic reader devices, mobile devices (e.g., desktop computer, notebook computer, smartphone, or any other type of computing device) and associated software (e.g. a browser capable of rendering output from information provided by, for example, user interface service 125).

The external system(s) 140 can be a third-party server and/or data store implemented as a computer system having logical elements. In an implementation, the logical elements may comprise program instructions recorded on one or more machine-readable storage media. Alternatively, the logical elements may be implemented in hardware, firmware, or a combination thereof. The external system(s) 140 may include one or more modules. In one example, the external system(s) 140 can include external model(s) 142. External model(s) 142 can be located external to the system 120, for example within one or more external system(s) 140. External model(s) 142 can be functionally similar or the same as internal model(s) 124 and/or the large language model service 128, and may be accessed, for example, via one or more APIs and/or the like.

Requestor device(s) 150 can include third-party servers or data stores implemented as a computer system having logical elements. In an implementation, the logical elements may comprise program instructions recorded on one or more machine-readable storage media. Alternatively, the logical elements may be implemented in hardware, firmware, or a combination thereof. Requestor device(s) 150 can request data from or transmit data to one or more modules of a system 120. For example, requestor device(s) 150 may transmit a request to execute a defined modeling objective and/or request output data from an executed model.

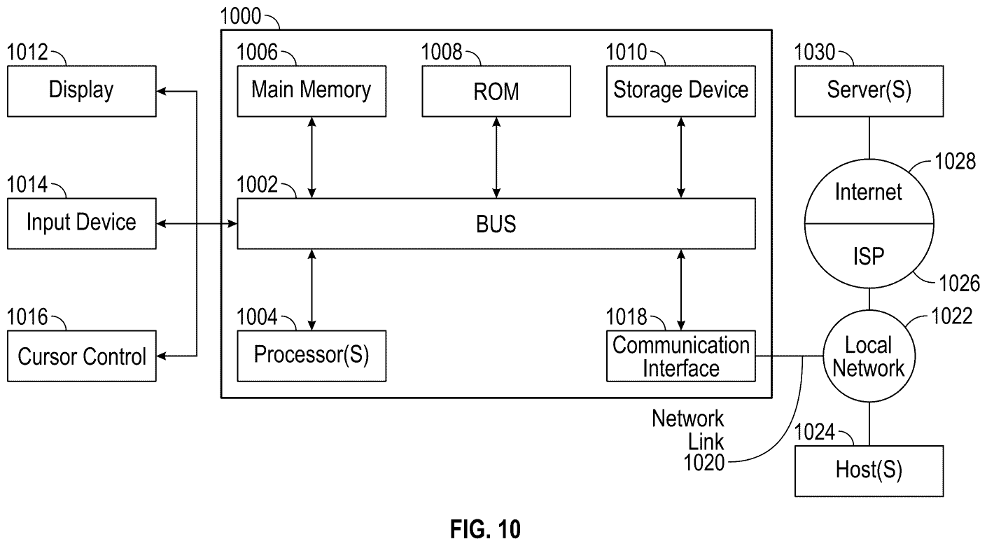

The network 110 can include any one or more communications networks, such as the Internet. The network 110 may be any combination of local area network (“LAN”) and/or a wireless area network (“WAN”) or the like. Accordingly, various components of the computing environment 100, including the system 120, can communicate with one another directly or indirectly via any appropriate communications links and/or networks, such as network 110 (e.g., one or more communications links, one or more computer networks, one or more wired or wireless connections, the Internet, any combination of the foregoing, and/or the like). Similarly, the various components (e.g., as described below) of the system 120 and the computing environment 100 may, in various implementations, communicate with one another directly or indirectly via any appropriate communications links (e.g., one or more communications links, one or more computer networks, one or more wired or wireless connections, the Internet, any combination of the foregoing, and/or the like). FIG. 10, described below, provides additional examples of aspects of implementations of such components of the computing environment 100, the system 120, and the like.

### III. Example Functionality of the Model Management System

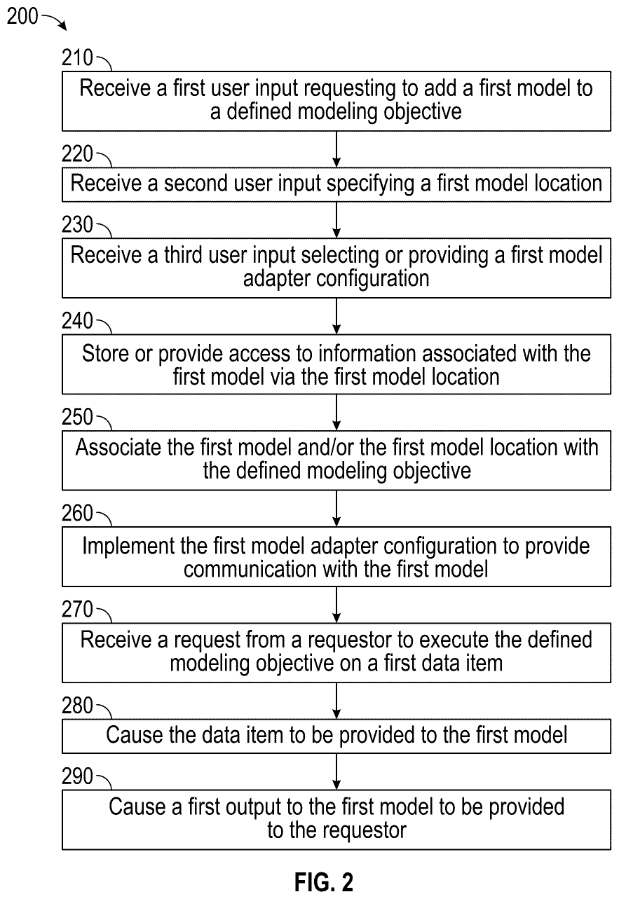

FIGS. 2-5 show flow charts illustrating example operations of the system 120 (and/or various other aspects of the example computing environment 100), according to various embodiments. The blocks of the flow charts illustrate example implementations, and in various other implementations various blocks may be rearranged, optional, and/or omitted, and/or additional block may be added. In various embodiments, the example operations of the system illustrated in FIGS. 2-5 may be implemented, for example, by the one or more aspects of the system 120, various other aspects of the example computing environment 100, and/or the like.

FIG. 2 is a flow chart depicting an example routine 200 for selecting and configuring a model as part of a system 120. As noted above, the system can receive one or more inputs from an interactive user interface and determine a modeling objective, select and add one or more models to the dependencies objective, provide access to the models via the modeling location information, configure the models via model-specific model adapter configurations, simulate the models in modeling environments, and manage prioritization of the models. The system can further, for each given defined modeling objective, execute a respective designated “production” model of the modeling objective when requests are received by the modeling objective. For example, a request to execute the modeling objective on particular data inputs may be received from a requestor, such as a user, another system, and/or various services. In response, the modeling objective may cause the data inputs to be provided to a model (e.g., a production model) of the modeling objective, and the model may be executed on the data inputs (e.g., in accordance with the model adapter configuration and/or other configurations associated with the model). Then, the output of the model can be provided back to the requestor via the defined modeling objective, as further described herein.

At block 210, the system receives a first user input requesting to add a first model to a defined modeling objective. For example, a first user input requesting to add a first model (and subsequent user input(s)) may be received by the system from one or more user device(s) 130 via user interface service 125. As noted above, the system can receive one or more user inputs requesting that a user select a model to be configured. The system may provide the user with one or more models for selection based on the defined modeling objective. The system can request that a user select an internal model located within the host system, or request selection or specification of an object representing a model hosted by a third-party platform. For example, specifying such an object can include providing details necessary for communicating and/or interacting with the model hosted by the third-party platform (e.g., via one or more APIs). Models located within the system can include both code representing the actual modeling data as well as object data representing characteristics of the model, while models hosted on third-party platforms may be represented by object data within the system. Object data representing characteristics defining parameters, interactions, and execution of either an internal model or a third-party model can include, for example, data sources, instructions, permissions, lineage, governance, auditability, and an allocation of resources.

At block 220, the system receives a second user input specifying a first model location. For example, the system may request that the user select a model location for the selected model. A model location can be, for example, a location within the system. As described above, the modeling location can store model data as well as object data defined for each model. Advantageously, model location selection is agnostic with models internal to the system as well as models externally hosted by a third-party platform because the system treats object data defined for internal and external models as similar assets. For example, substantiation and configuration of internal and external models, as well as user permissions may be included as part of an internal and external model's object data.

At block 230, the system receives a third user input selecting or providing a first model adapter configuration. As noted above, the system 120 can generate and/or the user can specify model adapter configurations based on user inputs. A model adapter configuration can include specific instructions defining implementation criteria of a selected internal or external model for a defined modeling objective, definitions and/or formats for expected data input and data output types of the model, specifications for parameters or properties of the model, scheduling instructions for dependencies, and/or instructions governing specific criteria for input and output data of a selected model within the defined modeling objective, called “fine-tuned” data as further described herein.

As described herein, the model adapter configuration instructions can be represented by, for example, a set of binary files or generic files determining the interaction between the system and the selected model for a defined modeling objective. Additionally, the user may be able to generate more than one model adapter configuration for a selected model, thereby providing the user with the flexibility to define a plurality of distinct instructions for incorporating a model into a defined modeling objective. Thus, the system's ability to generate model adapter configurations can provide a user with the means necessary to quickly generate complex binary files or generic files that are required to incorporate internal or external models into a system for a defined modeling objective.

At block 240, the system stores or provides access to information associated with the first model via the first model location. Information associated with the first model can include, for example, modeling objective data 121, model data 122, model adapter data 123, internal model(s) 124 and/or external model(s) 142, and/or the like. As described above, model location selection is agnostic with models internal to the system as well as models externally hosted by a third-party platform because the system treats object data defined for internal and external models as similar assets.

At block 250, the system associates the first model and/or the first model location with the defined modeling objective. For example, the first model and/or the first model location associated with the defined modeling objective can be included as part of the modeling objective data 121 and/or model adapter data 123. The system can configure a new model for a defined modeling objective hosted on the current system, generate a new model within the host system that maintains parity with a model hosted on another platform, or incorporate a third-party model hosted on a third-party platform, where the third-party model interacts with, but does not run on the host system (referred to as a “container route”). When integrating a third-party model via the container route, the system may be able to generate a container by packaging the third-party model as a binary asset and by moving the container onto the host system where the model can be consumed with other models. Advantageously, the system can integrate several opensource models into the system via the container route as further described herein.

At block 260, the system implements the first model adapter configuration to provide communication with the first model. For example, data including instructions for communicating with the first model, as well as additional instructions as described herein may be stored in model adapter data 123 and accessed by the system to configure a model for a defined modeling objective. As noted above, the system can generate and/or the user can specify model adapter configurations based on user inputs. A model adapter configuration can include specific instructions defining implementation criteria of a selected internal or external model for a defined modeling objective, definitions and/or formats for expected data input and data output types of the model, specifications for parameters or properties of the model, scheduling instructions for dependencies, and/or instructions governing specific criteria for input and output data of a selected model within the defined modeling objective, called “fine-tuned” data as further described herein.

At block 270, the system receives a request from a requestor to execute the defined modeling objective on a first data item. For example, a request may be received from requestor device(s) 150. The defined modeling objective may be executed by the modeling functionality service 126 in accordance with, for example, instructions based on the defined modeling objective's modeling objective data 121. This may include, for example, determining a “production” or otherwise designated model associated with the modeling objective (e.g., from a plurality of models associated with the modeling objective), for executing the model in accordance with the request from the requestor.

At block 280, the system causes the data item to be provided to the first model. For example, the data item can be input data provided to one or more models of the defined modeling objective, for example, via an interactive (live) mode where models are continuously applied to input data within a data pipeline, or a batch mode where the models are applied to a set of input data on a specific frequency. The modeling functionality service 126 may receive the data item from the system 120, requestor device(s) 150, client device(s) 130, and/or external system(s) 140, and provide the data item to the first model. The system can further, for each given defined modeling objective, execute a respective designated “production” model of the modeling objective when requests are received by the modeling objective. For example, a request to execute the modeling objective on particular data inputs may be received from a requestor, such as a user, another system, and/or various services. In response, the modeling objective may cause the data inputs to be provided to a model (e.g., a production model) of the modeling objective, and the model may be executed on the data inputs (e.g., in accordance with the model adapter configuration and/or other configurations associated with the model).

At block 290, the system causes the first output to the first model to be provided to the requestor. For example, modeling objective data 121 and/or model adapter data 123 may include instructions causing the modeling functionality service 126 to receive a first output of the first model based on the data item provided to the first model. Modeling functionality service 126 may transmit to requestor device(s) 150, user device(s) 130 and/or external system(s) 140, the first output of the first model. After the first output is provided to the requestor the routine 200 ends.

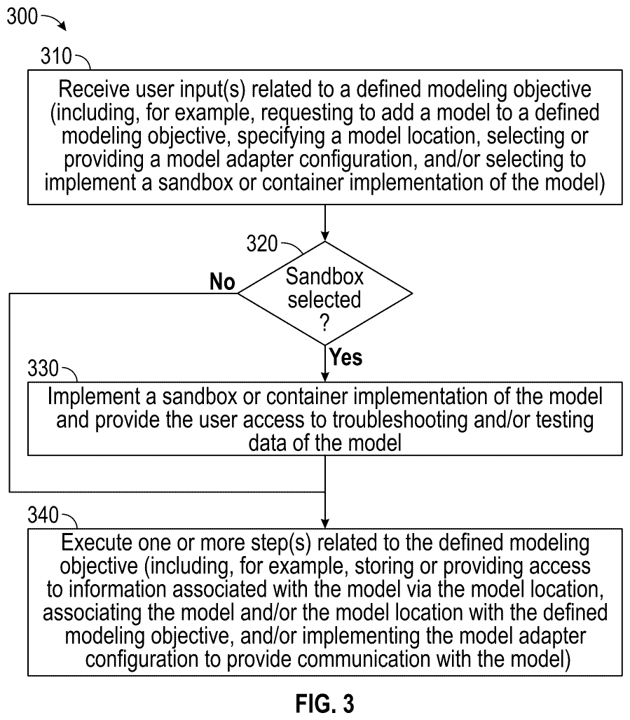

FIG. 3 is a flow chart depicting an example routine 300 for generating a simulation environment as part of a system 120.

At block 310, the system receives user input(s) related to a defined modeling objective (including for example, requesting to add a model to a defined modeling objective, specifying a model location, selecting or providing a model adapter configuration, and/or selecting to implement a sandbox simulation or container implementation of the model). For example, the system can receive one or more user input(s) from a user interacting with user device(s) 130 via user interface service 125. As noted above, the system can simulate one or more internal or external models through the “sandbox” simulation. The sandbox simulation can provide a simulated modeling environment for a defined modeling objective, allowing a user to test one or more configured models within a defined modeling objective prior to production releasing the models. Advantageously, a sandbox simulation may establish a simulated environment for an internal model hosted on the system or for an external model hosted by a third-party platform. When an external model hosted by a third-party is implemented as part of the sandbox simulation, a URL is generated by the sandbox simulation allowing the external model to easily access the sandbox simulation modeling environment. The modeling environment implemented within the sandbox simulation can be the same as, or of a similar type as the defined modeling objective as further described herein.

At decision node 320, the system determines whether the sandbox simulation is selected. If the sandbox simulation is selected, the routine may continue to block 330. If the sandbox simulation is not selected, the routine may bypass block 330 and continues to block 340. As noted above, the system can simulate one or more internal or external models through a “sandbox” simulation. The sandbox simulation can provide a simulated modeling environment for a defined modeling objective, allowing a user to test one or more configured models within a defined modeling objective prior to production releasing the models. Advantageously, a sandbox simulation may establish a simulated environment for an internal model hosted on the system or for an external model hosted by a third-party platform. When an external model hosted by a third-party is implemented as part of the sandbox simulation, a URL is generated by the sandbox simulation allowing the external model to easily access the sandbox simulation modeling environment. The modeling environment implemented within the sandbox simulation can be the same as, or of a similar type as the defined modeling objective. For example, the sandbox simulation environment can simulate an entire modeling objective or any portion of the defined modeling objective implementing the selected model or models. In a further example, the sandbox simulation can simulate an objective API environment, or one or more models that sources files and simulates an operational or computing environment within the system.

At block 330, the system implements a sandbox or container implementation of the model and provides the user access to troubleshooting and/or testing data of the model. The sandbox or container implementation can be executed by, for example simulation service 127 as described herein. Advantageously, the generated sandbox simulation of the system provides a means for resolving integration issues for one or more selected models without requiring the overhead of production releasing a model. For example, when a user requests a sandbox simulation for a selected model, the system can provide the user with access to troubleshooting and/or testing data (such as, e.g., testing points, performance data, telemetry data, asset utilization data, and/or the like), as well as access to input and output data of the selected model without affecting the defined modeling objective or other modeling objectives that may apply the selected model in production environments. As part of the sandbox simulation, a user may further configure characteristics of the simulation environment by setting maximum resource levels allocated to the selected model, or by setting permissions restricting access to the sandbox simulation. Advantageously, the system can provide an expiration time for the sandbox simulation. An expiration time can be determined based on a user input represented by, for example; a date, a time, or a duration. Once the expiration time passes, the system can automatically delete the sandbox simulation, which in turn deletes the simulated modeling environment for the selected model. Advantageously, deleting the simulated modeling environment can prevent waste and conserve energy and resources within the system as unused simulation environments may still consume energy and resources from the system even when not in use.

At block 340, the system executes one or more step(s) related to the defined modeling objective (including, for example, storing or providing access to information associated with the model via the model location, associating the model and/or the model location with the defined modeling objective, and/or implementing the model adapter configuration to provide communication with the model). The one or more steps can be the same and/or similar to steps included in FIG. 2. After the system executes the one or more steps of block 340 the routine 300 ends.

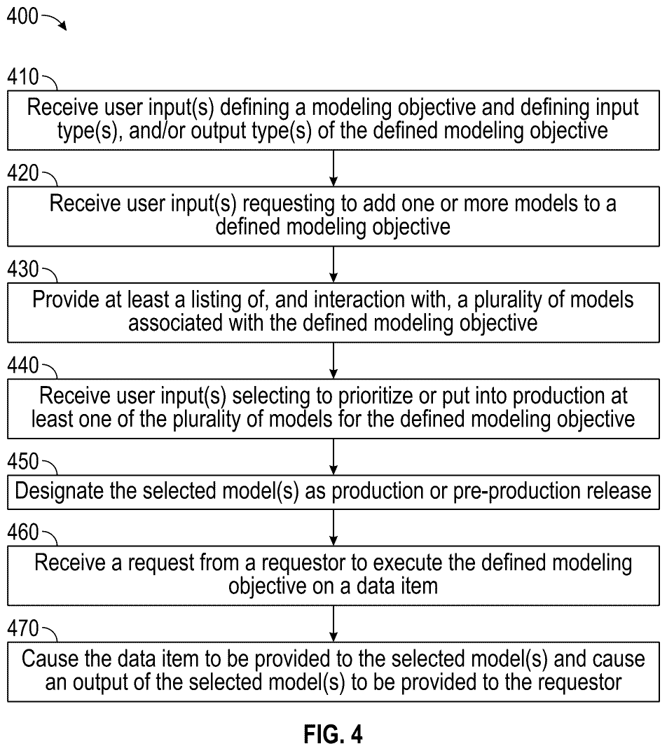

FIG. 4 is a flow chart depicting an example routine 400 for organizing one or more models as part of a system 120. As noted above, the system can request that a user define, and/or can receive from a user and/or other system, a modeling objective. A modeling objective can be associated with one or more models configured to execute a portion of, or the entire task or objective associated with the modeling objective. The defined modeling objective can include specifications regarding how input data from users, applications, or systems should be provided to the modeling objective (and/or consumed by one or more models associated with the modeling objective), and how output data to users, applications, or systems should be provided by the modeling objective. Such input and output specifications can include, for example, data formats, data schemas, data types, and/or the like. Such input and output specification of a defined modeling objective may be referred to as the objective API. Further, configuration of an objective API can define how inputs and outputs to the model should be mapped to an ontology of the system when invoked interactively. For example, a modeling objective can be used determining software vulnerabilities in a computer network. Inputs to such a modeling objective, as defined by the modeling objective data 121 can include real world properties such as name and/or type of computer or application, number of computers or applications in the computer network, and known or recent detected malware or virus attacks on same or similar computers or applications, while the modeling objective output as defined by the modeling objective data 121 can include an estimated vulnerability score for the computer network or parts thereof. As another example, a modeling objective can be used to determine housing prices in the United States. Inputs to such a modeling objective can include real world properties such as house location, number of rooms, square footage, and recently sold home prices, while the modeling objective output can include an estimated house price.

At block 410, the system receives user input(s) defining a modeling objective. Additionally, the system receives user input(s) defining input type(s), and/or output type(s) of the defined modeling objective. For example, user interface service 125 may receive one or more inputs from user device(s) 130 indicating a description and/or purpose of the modeling objective, as well as an objective API such as input type(s) and/or output type(s) or formats. Input type(s) and/or output type(s) can include, for example, a string, text, binary, floating point, character, Boolean, timestamp, and/or date.

At block 420, the system receives user input(s) requesting to add one or more models to a defined modeling objective. For example, this step can be the same and/or similar to block 210 of FIG. 2.

At block 430, the system provides at least a listing of, and interaction with, a plurality of models associated with the defined modeling objective. For example, the system can provide the user with an organized representation and interaction with a listing of models and the different contexts where each model is used within the system via a GUI generated by user interface service 125. As described further herein, the system can display a list of models for a defined modeling objective and provide for selection of one or more models for deployment (and/or, for example, prioritizing). The system can provide the user with an organized representation and interaction with a listing of models and the different contexts where each model is used within the system. Advantageously, a display of models and the different context where the models are implemented can be leveraged by a user to quickly conduct an impact analysis and determine the scope of possible changes when considering whether to promote a selected model from, for example, a staged released (e.g., pre-production release) version to a production released version.

At block 440, the system receives user input(s) selecting to prioritize or put into production at least one of the plurality of models for the defined modeling objective. For example, a user may select, based on a GUI provided by user interface service 125, a model to be promoted to a staged release (e.g., pre-production) and/or a production release as described herein.

At block 450, the system designates selected model(s) as production and/or or pre-production releases based on the received user input(s). In one example, the modeling functionality service 126 may receive the selection and determine whether to promote the selected model from, for example, a staged released (e.g., pre-production release) version to a production released version. If the modeling functionality service 126 designates the selected model as a staged released version, the model can represent a version-controlled model for use in a testing environment, providing access for the user or a third-party user to interact with the promoted model without affecting production releases of the model. If the modeling functionality service 126 designates the selected model as a production released version, the modeling functionality service 126 may automatically deploy the newly promoted model within each modeling objective where the selected model is labeled for production use. In another example, after sandbox simulation testing of a selected model, the system can promote the selected model to a staged release (e.g., pre-production). The system designated staged released version of a model can represent a version-controlled model for use in a testing environment, providing access for the user or a third-party user to interact with the promoted model without affecting production releases of the model. Further, the system may promote the selected model to a production released version.

At block 460, the system receives a request from a requestor to execute the defined modeling objective on a data item. For example, this step can be the same and/or similar to block 270 of FIG. 2

At block 470, the system causes the data item to be provided to the selected model(s) and causes an output of the selected model(s) to be provided to the requestor. For example, this step can be the same and/or similar to blocks 280 and/or 290 of FIG. 2. After the system executes the steps of block 470 the routine 400 ends.

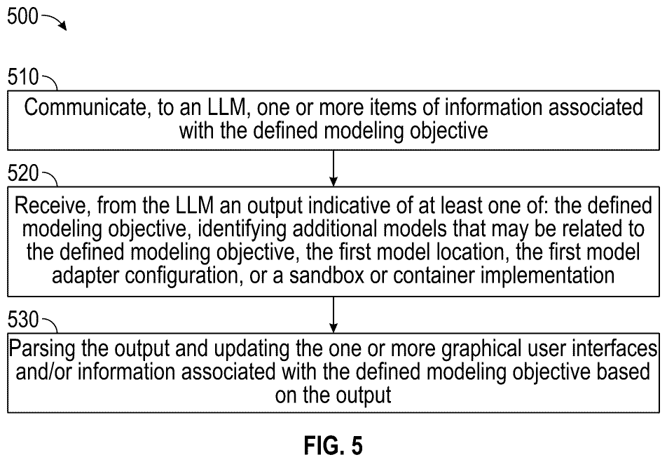

FIG. 5 is a flow chart depicting an example routine 500 for using a large language model as part of a system 120.

At block 510, the system communicates to an LLM, one or more items of information associated with the defined modeling objective and/or the system. The one or more items of information associated with the defined modeling objective can include, for example, defining a modeling objective, identifying additional models that may be related to the defined modeling objective, the first model location, the first model adapter configuration, a sandbox or container implementation, input and output specifications of a defined modeling objective and/or the like. The LLM is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a neural network trained using self-supervised learning. An LLM may be of any type, including a Question Answer (“QA”) LLM that may be optimized for generating answers from a context.

At block 520, the system receives, from the LLM, an output indicative of at least one of: the defined modeling objective, identifying additional models that may be related to the defined modeling objective, the first model location, the first model adapter configuration, and/or a sandbox or container implementation. Additionally, and/or alternatively, the system may receive, from the LLM, an output indicative of items of information associated with the defined modeling objective and/or the system.

At block 530, the system parses the output and updates the one or more GUIs and/or information associated with the defined modeling objective and/or the system based on the output. For example, based on the output of the LLM, the system can update a GUI with results of a search for one or more models and/or the system can update any other information associated with the defined modeling objective and/or system. The system may update information including modeling objective data 121, model data 122, model adapter data 123, internal model(s) 124, sandbox simulation environments, deployment and prioritizing data, external model(s) 142 and/or any other information associated with the defined modeling objective and/or the system. As noted herein, and based on the output of the LLM, the system can update information, such as one or more inputs to an interactive user interface, determine a modeling objective, select and add one or more models to the dependencies objective, provide access to the models via the modeling location information, configure the models via model-specific model adapter configurations, simulate the models in modeling environments, and manage prioritization of the models. Based on the output of the LLM, the system can further, for each given defined modeling objective, execute a respective designated “production” model of the modeling objective when requests are received by the modeling objective. For example, the output of an LLM may request to execute the modeling objective on particular data inputs received from a requestor. Further, the LLM may update the system to cause the data inputs to be provided to a model (e.g., a production model) of the modeling objective, and the model may be executed on the data inputs (e.g., in accordance with the model adapter configuration and/or other configurations associated with the model). Then, the output of the model can be provided back to the requestor via the defined modeling objective, as further described herein.

### IV. Example User Interfaces of a Model Management Integration Framework

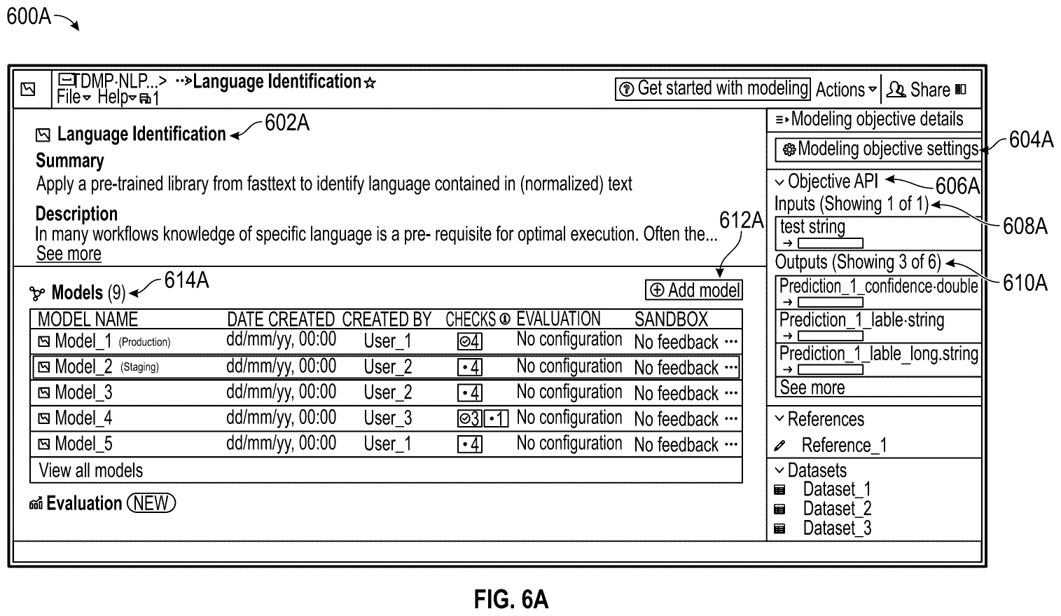

FIGS. 6A-6B, 7A-7B, 8, and 9 illustrate an example user interface of the system 120 as provided by, for example, user interface service 125. FIG. 6A illustrates an example user interface 600A permitting the user to select various criteria when defining a modeling objective. The example user interface 600A illustrates various example functionality of the system described, for example, in reference to block 210 of routine 200, and/or blocks 410, 420, and 430 of routine 400. Advantageously, the example user interface 600A may allow the user to define input type(s) and output type(s) for a defined modeling objective, add one or models to the defined modeling objective, and/or provide a listing and interacting with, a plurality of models associated with the defined modeling objective. As part of example user interface 600A, a user may begin by defining modeling objective via modeling objective settings 604A. Based on the user's selection, the modeling objective display 602A can indicate the user's defined modeling objective. In the example user interface 600A, the user has selected a language identification modeling objective. The language identification objective can, for example, apply a pre-trained library from an open source model for learning of word embeddings and text classification to identify language contained in normalized text. Modeling objective settings 604A may further define modeling objective data 121, which can include, for example, a selection of specification data 606A. In the example user interface 600A, specification data 606A is an objective API. However, specification data 606A can be any form of specification data as defined herein. The user may select, for example, input specifications 608A and output specifications 610A, which can include, for example, data formats, data schemas, data types, and/or the like. Input specifications 608A, as depicted in the example user interface 600A include one input data type “text” having a corresponding data format of “string”. Output specifications 610A, as depicted in the example user interface 600A, include three output data types: a confidence prediction having a corresponding “double” data format, a label prediction having a corresponding “string” data format, and a label prediction_long, having a corresponding “string” data format. Advantageously, the user may select one or more input specifications 608A and/or output specifications 610A, as well as one or more data type(s) as described herein.

The example user interface 600A further includes an input to add a model 612A. The user may add one or more internal and/or external models to the defined modeling objective as described herein. Additionally, the user is provided with a listing 614A, including a plurality of models associated with the defined modeling objective. The listing 614A is an interactive listing providing the user with model data, such as data associated with model data 122. For example, listing 614A can include a table containing version control data, the date the model was created, the user who generated the model, “checks” depicting debugging data, evaluations of the model, and/or whether there is a sandbox or container implementation of the model exists, or the like. Additionally, listing 614A includes an indication that Model_1 is a “Production” released model for the defined modeling objective. Further, listing 614A includes an indication that Model_2 is a “Staging” model of the defined modeling objective. As noted herein, the system can promote a selected model to a staged release (e.g., pre-production) and/or a production release. The system designated staged released version of a model can represent a version-controlled model for use in a testing environment, providing access for the user or a third-party user to interact with the promoted model without affecting production releases of the model. Further, the system may promote the selected model to a production released version. When the system designates the selected model as a production released version, the system may automatically deploy the newly promoted model within each modeling objective where the selected model is labeled for production use.

FIG. 6B is an example user interface 600B for prioritizing one or more models within a defined modeling objective. As part of the example user interface 600B, a GUI can display a portion illustrating release(s) of a selected model. For example, staged release data 602B and production released data 604B for a selected model. The staged release data 602B and production released data 604B for a selected model can include a defined version number, a model name, date, and/or the last user to edit the model. Additionally, production data 606B and/or staging data 608B for the selected model can be provided in the example user interface 600B. The production data 606B and/or staging data 608B can include, for example, a listing of deployments for the selected model, whether the model receives data continuously (also called “live”) or in batches, the last update for the model, version information, health of the model, and/or whether the model is upgraded. The example user interface 600B can include a selection to create a deployment 610B of a model. The deployment 610B can be selected, for example, to generate a staged release of a model. The example user interface 600B can further include a selection to release a model 612B. If a user selects to release a model 612B, the system can promote a selected model from, for example, a staged released (e.g., pre-production release) version to a production released version.

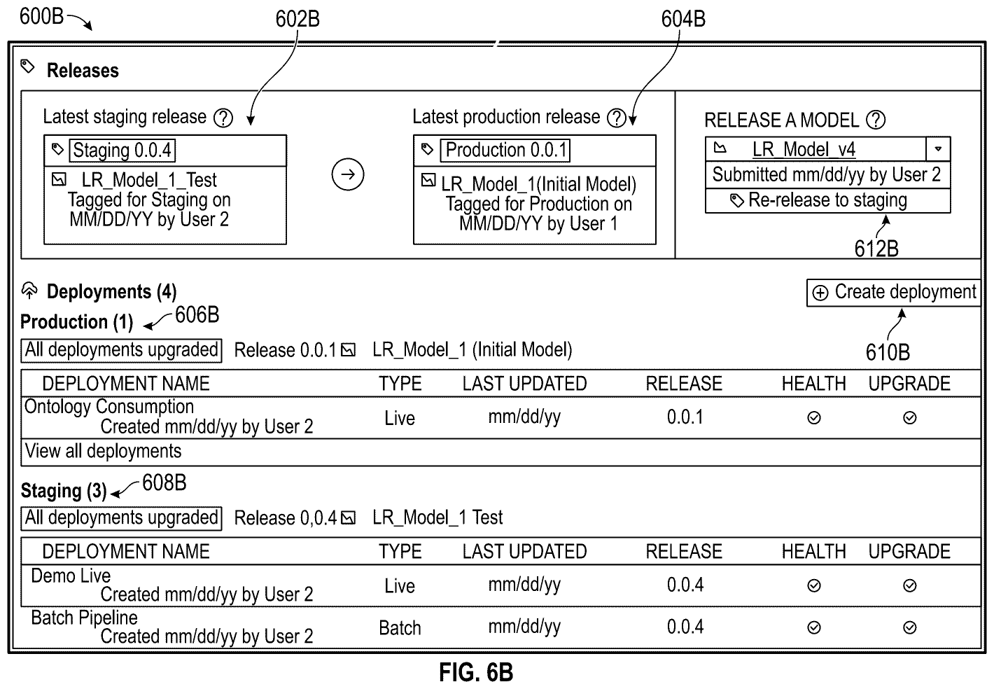

FIG. 7A is example user interface 700A for selecting one or more models to be configured as part of a defined modeling objective. User interface 700A can be provided to the user after, for example, a selection to add a model 612A to a defined modeling objective. Example user interface 700A can include a navigation portion 702A indicating one or more steps associated with importing and/or selecting one or more models. The user may be presented with a model location 704A. The model location 704A can include, for example a file path within the system 120 and/or a file path and/or URL to one or more external system(s) 140. Additionally, user interface 700A may display a listing of available models 706A within a selected model location 704A.

FIG. 7B is an example user interface 700B for selecting a model location for the model to be configured. After the user has selected a model to be configured, the user may be provided with an option to select a location 702B where the selected model will be stored. The system 120 may allow a user to generate a new location within the system, and/or allow the user to store the model externally, for example on external system(s) 140. User interface 700B may also provide the current model location information 704B for the selected model.

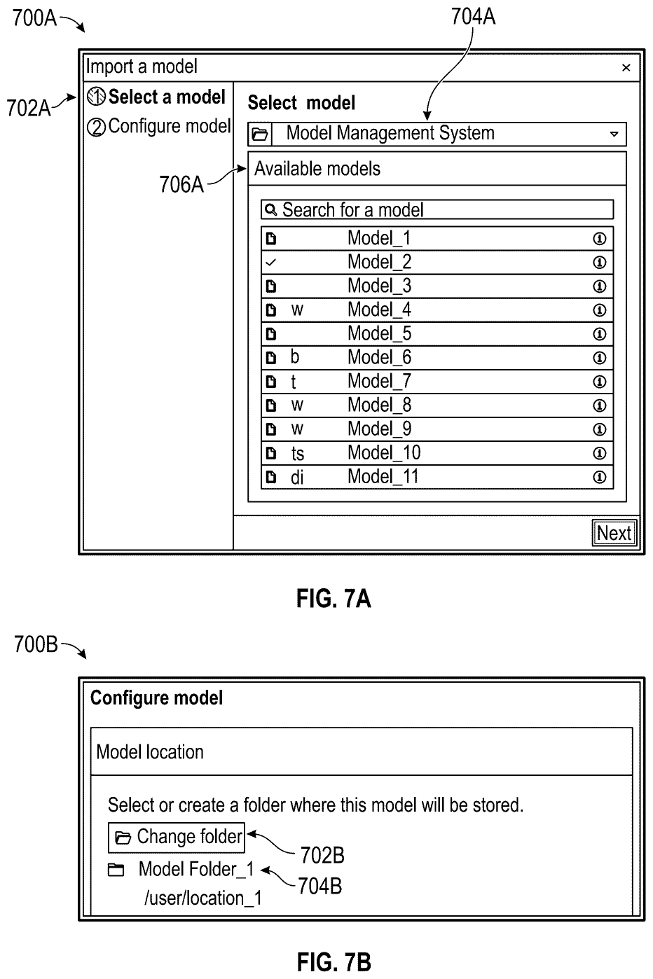

FIG. 8 is an example user interface 800 for generating and/or specifying model adapter configurations. A user can manually specify model adapter configurations 802. If the user selects to manually the specify model adapter configuration 802, model adapter data 123 may be generated based on the user's selection of a set of binary files or generic files determining the interaction between the system and the selected model for a defined modeling objective. Alternatively, the user can select model dependencies 804 and/or add dependencies 806. The dependencies can include a list of necessary data to be accessed and consumed by the selected model, or specific rules based on the operating platform of the model.

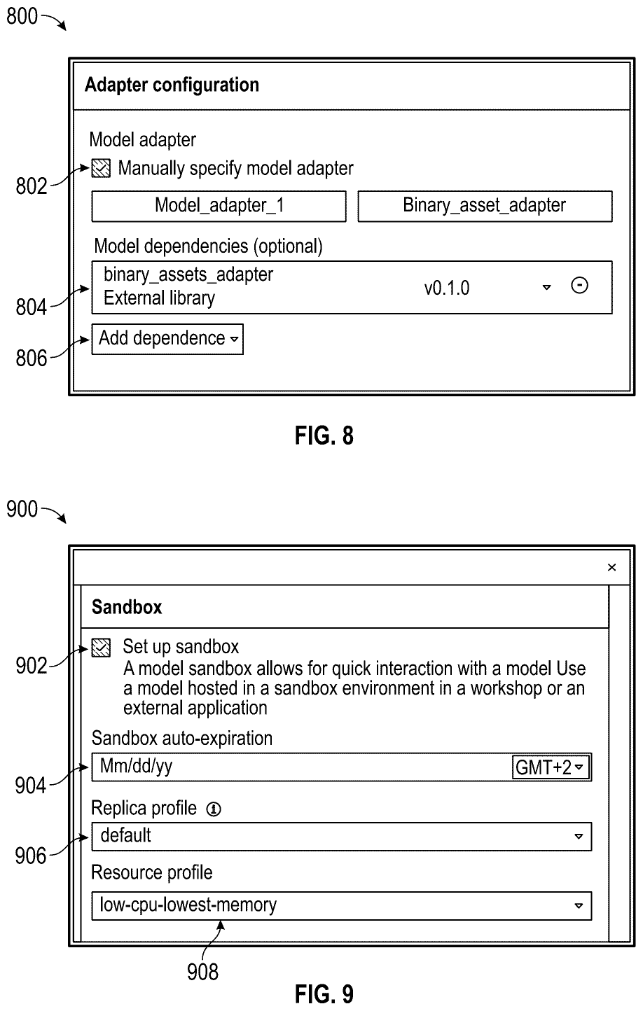

FIG. 9 is an example user interface 900 for providing a simulated modeling environment for a defined modeling objective. The simulated modeling environment may allow a user to test one or more configured models within a defined modeling objective prior to production releasing the models. A user may be presented with an option to set up a sandbox 902. Additionally, the user may be presented with an auto-expiration selection 904. The auto-expiration selection 904 may enable the system 120 to automatically delete the sandbox simulation, which in turn can delete the simulated modeling environment for the selected model. In the present example user interface 900, the user selects a date when the sandbox simulation is to expire, however the selection 904 may be another period such as a time and/or a duration (or the like) described herein. Additionally, the user may further configure characteristics of the sandbox simulation 906 and 908 by setting permissions restricting access to the sandbox simulation, or by setting maximum resource levels allocated to the selected model respectively.

### V. Additional Example Implementations and Details

In an implementation the system (e.g., one or more aspects of the system 120, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 10) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, Vx Works, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 10 shows a block diagram that illustrates a computer system 1000 upon which various implementations and/or aspects (e.g., one or more aspects of the operating environment 100, one or more aspects of the model management system 120, one or more aspects of the user device(s) 130, one or more aspects of the external system(s) 140, one or more aspects of the requestor device(s) 150, and/or the like) may be implemented. Multiple such computer systems 1000 may be used in various implementations of the present disclosure. Computer system 1000 includes a bus 1002 or other communication mechanism for communicating information, and a hardware processor, or multiple processors, 1004 coupled with bus 1002 for processing information. Hardware processor(s) 1004 may be, for example, one or more general purpose microprocessors.

Computer system 1000 also includes a main memory 1006, such as a random-access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. The main memory 1006 may, for example, include instructions to implement server instances, queuing modules, memory queues, storage queues, user interfaces, and/or other aspects of functionality of the present disclosure, according to various implementations.

Computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), and/or the like, is provided and coupled to bus 1002 for storing information and instructions.

Computer system 1000 may be coupled via bus 1002 to a display 1012, such as a cathode ray tube (CRT) or LCD display (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computing system 1000 may include a user interface module to implement a GUI that may be stored in a mass storage device as computer executable program instructions that are executed by the computing device(s). Computer system 1000 may further, as described below, implement the techniques described herein using customized hard-wired logic, one or more ASICs or FPGAs, firmware and/or program logic which in combination with the computer system causes or programs computer system 1000 to be a special-purpose machine. According to one implementation, the techniques herein are performed by computer system 1000 in response to processor(s) 1004 executing one or more sequences of one or more computer-readable program instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN (or WAN component to communicated with a WAN). Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### VI. Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computer-implemented method for managing one or more models, the computer-implemented method comprising, by one or more hardware processors executing program instructions: receiving, from a user and via one or more graphical user interfaces, one or more user inputs including at least: a first user input requesting to add a first model to a defined modeling objective; a second user input specifying a first model location; and a third user input selecting or providing a first model adapter configuration; in response to the one or more user inputs: storing or providing access to information associated with the first model via the first model location; associating the first model and/or the first model location with the defined modeling objective; and implementing the first model adapter configuration to provide communication with the first model; and in response to a first request from a requestor to execute the defined modeling objective on a first data item: causing the first data item to be provided to the first model; and causing a first output of the first model to be provided to the requestor.

Clause 2. The computer-implemented method of Clause 1, wherein: the one or more user inputs further include: a further user input selecting to implement a first sandbox or container implementation of the first model; and the computer-implemented method further comprises, by the one or more hardware processors executing program instructions: further in response to the one or more user inputs: implementing the first sandbox or container implementation of the first model.

Clause 3. The computer-implemented method of Clause 2 further comprising, by the one or more hardware processors executing program instructions: providing the user access to test inputs and outputs of the first model via the first sandbox or container implementation of the first model without placing the first model into a production environment.

Clause 4. The computer-implemented method of Clause 2 further comprising, by the one or more hardware processors executing program instructions: providing the user access to troubleshooting and/or testing data of the first model via the first sandbox or container implementation of the first model without placing the first model into a production environment.

Clause 5. The computer-implemented method of any of Clauses 1-4,wherein the first model adapter configuration includes at least one of: definitions or formats for inputs and outputs of the first model, or specifications for parameters or properties of the first model.

Clause 6. The computer-implemented method of Clause 5, wherein the definitions or formats for inputs and outputs of the first model include at least one of: data types, number of columns, column header information, or data format.

Clause 7. The computer-implemented method of Clause 5, wherein the specifications for parameters or properties of the first model include at least one of: dependencies, rules, input data processing type, or domain specific language.

Clause 8. The computer-implemented method of any of Clauses 1-7 further comprising, by the one or more hardware processors executing program instructions: receiving, from the user and/or another user, and via one or more graphical user interfaces, a second one or more user inputs including at least a fourth user input requesting to add a second model to the defined modeling objective; and in response to the second one or more user inputs, associating the second model and/or a second model location with the defined modeling objective.

Clause 9. The computer-implemented method of Clause 8 further comprising, by the one or more hardware processors executing program instructions: receiving, from the user and/or another user, and via one or more graphical user interfaces, a fifth user input selecting to prioritize or put into production the second model for the defined modeling objective.

Clause 10. The computer-implemented method of Clause 9, wherein selecting to prioritize or put into production the second model comprises at least one of: designating as a pre-production release, or designating as production release.

Clause 11. The computer-implemented method of any of Clauses 9-10 further comprising, by the one or more hardware processors executing program instructions: in response to a second request from the requestor to execute the defined modeling objective on a second data item: causing the second data item to be provided to the second model; and causing a second output of the second model to be provided to the requestor.

Clause 12. The computer-implemented method of any of Clauses 8-11, wherein: the second one or more user inputs further include: a fifth user input specifying a second model location; a sixth user input selecting or providing a second model adapter configuration; and a seventh user input selecting to implement a second sandbox or container implementation of the second model; and the computer-implemented method further comprises, by the one or more hardware processors executing program instructions: further in response to the second one or more user inputs: storing or providing access to information associated with the second model via the second model location; implementing the second model adapter configuration to provide communication with the second model; and implementing the second sandbox or container implementation of the second model.

Clause 13. The computer-implemented method of any of Clauses 1-12, wherein the defined modeling objective is associated with a plurality of models, and wherein the defined modeling objective defines at least: one or more input types, and one or more output types, of the defined modeling objective.

Clause 14. The computer-implemented method of Clause 13 further comprising, by the one or more hardware processors executing program instructions: providing the user and/or another user with an interactive graphical user interface configured to provide at least a listing of, and interaction with, the plurality of models associated with the defined modeling objective.

Clause 15. The computer-implemented method of any of Clauses 1-14, wherein the requestor is at least one of: the user, another user, or a computer system or computer process.

Clause 16. The computer-implemented method of any of Clauses 1-15, wherein information associated with the first model includes an allocation of resources to execute the first model.

Clause 17. The computer-implemented method of any of Clauses 1-16, wherein the computer-implemented method further comprises, by the one or more hardware processors executing program instructions: communicating, to a large language model (“LLM”), one or more items of information associated with the defined modeling objective; receiving, from the LLM, an output indicative of at least one of: the defined modeling objective, identify additional models that may be related to the defined modeling objective, the first model location, the first model adapter configuration, or a sandbox or container implementation; and parsing the output and updating the one or more graphical user interfaces and/or information associated with the defined modeling objective based on the output.

Clause 18. A system comprising: one or more computer-readable storage mediums having program instructions embodied therewith; and one or more processors configured to execute the program instructions to cause the system to perform the computer-implemented method of any of Clauses 1-17.

Clause 19. A computer program product comprising one or more computer-readable storage mediums having program instructions embodied therewith, the program instructions executable by one or more processors to cause the one or more processors to perform the computer-implemented method of any of Clauses 1-17.

What is claimed is:

1. A computer-implemented method for managing one or more models, the computer-implemented method comprising, by one or more hardware processors executing program instructions:
receiving, from a user and via one or more graphical user interfaces, one or more user inputs including at least:
a first user input requesting to add a first model to a defined modeling objective;
a second user input specifying a first model location; and
a third user input selecting or providing a first model adapter configuration;
in response to the one or more user inputs:
storing or providing access to information associated with the first model via the first model location;
associating the first model and/or the first model location with the defined modeling objective; and
implementing the first model adapter configuration to provide communication with the first model; and
in response to a first request from a requestor to execute the defined modeling objective on a first data item:
causing the first data item to be provided to the first model; and
causing a first output of the first model to be provided to the requestor.

2. The computer-implemented method of claim 1, wherein:
the one or more user inputs further include:
a further user input selecting to implement a first sandbox or container implementation of the first model; and
the computer-implemented method further comprises, by the one or more hardware processors executing program instructions:
further in response to the one or more user inputs:
implementing the first sandbox or container implementation of the first model.

3. The computer-implemented method of claim 2 further comprising, by the one or more hardware processors executing program instructions:
providing the user access to test inputs and outputs of the first model via the first sandbox or container implementation of the first model without placing the first model into a production environment.

4. The computer-implemented method of claim 2 further comprising, by the one or more hardware processors executing program instructions:
providing the user access to troubleshooting and/or testing data of the first model via the first sandbox or container implementation of the first model without placing the first model into a production environment.

5. The computer-implemented method of claim 4, wherein the first model adapter configuration includes at least one of: definitions or formats for inputs and outputs of the first model, or specifications for parameters or properties of the first model.

6. The computer-implemented method of claim 5, wherein the definitions or formats for inputs and outputs of the first model include at least one of: data types, number of columns, column header information, or data format.

7. The computer-implemented method of claim 5, wherein the specifications for parameters or properties of the first model include at least one of: dependencies, rules, input data processing type, or domain specific language.

8. The computer-implemented method of claim 7 further comprising, by the one or more hardware processors executing program instructions:
receiving, from the user and/or another user, and via one or more graphical user interfaces, a second one or more user inputs including at least a fourth user input requesting to add a second model to the defined modeling objective; and
in response to the second one or more user inputs, associating the second model and/or a second model location with the defined modeling objective.

9. The computer-implemented method of claim 8 further comprising, by the one or more hardware processors executing program instructions:
receiving, from the user and/or another user, and via one or more graphical user interfaces, a fifth user input selecting to prioritize or put into production the second model for the defined modeling objective.

10. The computer-implemented method of claim 9, wherein selecting to prioritize or put into production the second model comprises at least one of: designating as a pre-production release, or designating as production release.

11. The computer-implemented method of claim 10 further comprising, by the one or more hardware processors executing program instructions:
in response to a second request from the requestor to execute the defined modeling objective on a second data item:
causing the second data item to be provided to the second model; and
causing a second output of the second model to be provided to the requestor.

12. The computer-implemented method of claim 11, wherein:
the second one or more user inputs further include:
a fifth user input specifying a second model location;
a sixth user input selecting or providing a second model adapter configuration; and
a seventh user input selecting to implement a second sandbox or container implementation of the second model; and
the computer-implemented method further comprises, by the one or more hardware processors executing program instructions:
further in response to the second one or more user inputs:
storing or providing access to information associated with the second model via the second model location;
implementing the second model adapter configuration to provide communication with the second model; and
implementing the second sandbox or container implementation of the second model.

13. The computer-implemented method of claim 12, wherein the defined modeling objective is associated with a plurality of models, and wherein the defined modeling objective defines at least: one or more input types, and one or more output types, of the defined modeling objective.

14. The computer-implemented method of claim 13 further comprising, by the one or more hardware processors executing program instructions:
providing the user and/or another user with an interactive graphical user interface configured to provide at least a listing of, and interaction with, the plurality of models associated with the defined modeling objective.

15. The computer-implemented method of claim 14, wherein the requestor is at least one of: the user, another user, or a computer system or computer process.

16. The computer-implemented method of claim 15, wherein information associated with the first model includes an allocation of resources to execute the first model.

17. The computer-implemented method of claim 16, wherein the computer-implemented method further comprises, by the one or more hardware processors executing program instructions:
communicating, to a large language model (“LLM”), one or more items of information associated with the defined modeling objective;
receiving, from the LLM, an output indicative of at least one of:
the defined modeling objective,
identify additional models that may be related to the defined modeling objective,
the first model location,
the first model adapter configuration, or
a sandbox or container implementation; and
parsing the output and updating the one or more graphical user interfaces and/or information associated with the defined modeling objective based on the output.

18. A system comprising:
one or more computer-readable storage mediums having program instructions embodied therewith; and
one or more processors configured to execute the program instructions to cause the system to perform the computer-implemented method of any of claim 1.

19. A computer program product comprising one or more computer-readable storage mediums having program instructions embodied therewith. the program instructions executable by one or more processors to cause the one or more processors to perform the computer-implemented method of claim 1.
